(19) United States
(12) Patent Application Publication
(10) Pub. No.: US 2026/0244913 A1
(43) Pub. Date: Aug. 20, 2026

(54) BLOCK-CENTRIC ACCELERATION SYSTEM AMD METHOD FOR HETEROGENEOUS GRAPH NEURAL NETWORKS

(71) Applicant: HUAZHONG UNIVERSITY OF SCIENCE AND TECHNOLOGY, Wuhan, Hubei (CN)

(72) Inventors: Yu ZHANG, Wuhan (CN); Ruida XIN, Wuhan (CN); Jin ZHAO, Wuhan (CN); Hui YU, Wuhan (CN); Xiaofei LIAO, Wuhan (CN); Hai JIN, Wuhan (CN)

(21) Appl. No.: 19/425,340

(22) Filed: Dec. 18, 2025

(30) Foreign Application Priority Data
Feb. 18, 2025 (CN) 202510178996.3

(51) Int. Cl. G06N 3/063; G06F 17/16

(52) U.S. Cl. CPC G06N 3/063; G06F 17/16

(57) ABSTRACT

A block-centric acceleration system and method for heterogeneous graph neural networks (HGNNs) are provided. The system includes a processor comprising a block loading unit, a block scheduling unit, processing units, and a reduction unit. The block loading unit identifies central blocks and constructs a block overlap graph, prioritizing the central blocks based on their degrees of overlap. The block scheduling unit dynamically assigns prioritized blocks to idle processing units. The processing units perform computations using row-wise matrix multiplication and element-wise operations, thereby carrying out hybrid computation for HGNN inference and generating intermediate results corresponding to structural and semantic aggregation within the block overlap graph. The reduction unit determines an aggregation status flag based on results from the processing units and outputs semantic features upon completion of structural and semantic aggregation. The present disclosure reduces redundant feature access, improves processing efficiency, and lowers memory bandwidth requirements.

### BACKGROUND OF THE APPLICATION

### 1. Technical Field

The present disclosure generally relates to graph computing, and more particularly to a block-centric acceleration system for heterogeneous graph neural networks and a method thereof.

### 2. Description of Related Art

A heterogeneous graph refers to a graph structure comprising multiple types of vertices and edges, wherein the vertices represent different types of entities and the edges denote relationships among the entities. Such a graph structure is commonly found in real-world applications, including social networks, recommendation systems, and knowledge graphs, which contain abundant heterogeneous information.

Heterogeneous graph neural networks (HGNNs) are configured to capture complex structural and semantic information of heterogeneous graphs, thereby exhibiting capabilities superior to those of common graph neural networks (GNNs) in multiple fields, including fraud detection and personalized recommendation. To facilitate better understanding and utilization of such information, meta-path-based heterogeneous graph neural networks have been extensively studied and developed. A meta path, defined as an ordered sequence of vertex types and edge types, is configured to represent composite relationships among vertices, thereby enhancing the capability of the model to comprehend heterogeneous graphs.

Nevertheless, the current HGNN inference process still encounters some challenges. First, existing methods generally aggregate features based on the storage order of meta-path instances, which leads to limited or no reuse of vertex features between consecutive inference batches, thereby degrading data locality and incurring additional memory accesses. Second, as most meta-paths exhibit symmetric characteristics, a vertex may function as both the starting point and the ending point of another meta-path, thereby aggravating redundant feature access and imposing considerable memory bandwidth consumption.

CN118036688A discloses an inference accelerator for HGNNs, which is schematically added with a graph decoupler and a graph reassembler to divide subgraphs through graph decoupling and reorganization of the heterogeneous graph, and sends the subgraphs to downstream processing components for further processing so as to realize inference on the HGNN. Through the inclusion of the graph decoupler and the graph reassembler, the semantic graph corresponding to the heterogeneous graph is partitioned into multiple subgraphs exhibiting stronger locality, thereby mitigating cache thrashing during processing. The processing of the subgraphs corresponding to the semantic graph is equivalent to the processing of the original semantic graph, thus ensuring correctness while enhancing execution performance. However, the disclosed technical solution does not implement optimization specifically targeting meta-path processing of heterogeneous graphs during the decoupling and reorganization procedures. The subgraph partitioning granularity remains relatively coarse, resulting in suboptimal data locality and residual cache thrashing. Moreover, the incorporation of the graph decoupler and graph reassembler into the accelerator architecture may increase overall system complexity under large-scale graph data workloads, and may introduce additional processing latency during decoupling and reorganization. Additionally, the current accelerator may perform multiple accesses to identical feature vectors during processing, thereby incurring redundant memory accesses and computational overhead.

Hence, there is a pressing need for improving the processing efficiency for HGNNs.

Note that, due to potential discrepancies in understanding among those skilled in the art, and the extensive literature and patents reviewed by the applicant during development, not all details are listed due to space constraints. This does not imply that the present disclosure lacks existing art features; rather, it encompasses all relevant existing art features. The applicant reserves the right to supplement this application with further details and features from related existing art, as appropriate, in accordance with relevant regulations.

### SUMMARY OF THE APPLICATION

The current HGNN inference process still encounters several challenges. First, existing methods generally aggregate features based on the storage order of meta-path instances, which leads to only a small portion or none of the vertex features being reused between consecutive inference batches. This reduces data locality and incurs additional, unnecessary memory accesses. Second, as most meta-paths exhibit symmetric characteristics, a vertex may function as both the starting point and the ending point of another meta-path. This not only aggravates redundant feature access but also consumes a substantial amount of memory bandwidth.

To address the deficiencies in the prior art, the present disclosure provides, in a first aspect, a block-centric acceleration system for heterogeneous graph neural networks (HGNNs), which includes a processor. The processor comprises a block loading unit, a block scheduling unit, processing units, and a reduction unit. The block loading unit is configured to identify central blocks and construct a block overlap graph, and to prioritize the central blocks based on their degree of overlap. The block scheduling unit dynamically assigns the prioritized central blocks to idle processing units. The processing units compute each central block using a combination of row-wise matrix multiplication and element-wise operations, thereby performing hybrid computation for HGNN inference and generating intermediate aggregation results for both structural and semantic aggregation in the block overlap graph. The reduction unit determines an aggregation status flag based on the received intermediate results from the processing unit, and outputs the semantic features when structural and semantic aggregation are completed.

In the present disclosure, the block loading unit identifies adjacent vertices connected to a central vertex, thereby effectively locating important connectivity regions within the heterogeneous graph. By prioritizing central blocks with a high degree of overlap, unnecessary memory accesses are reduced, vertex feature reuse is maximized, and both data locality and processing efficiency are improved. The block scheduling unit enables efficient utilization of computational resources by flexibly scheduling tasks such that computations are promptly executed whenever the processing units are idle, thereby reducing delays caused by waiting. This dynamic allocation mechanism improves overall computing efficiency and enhances the response speed of HGNN inference. The processing units employ a hybrid computing approach, allowing multiple types of computations (e.g., graph convolution and feature aggregation) to be executed concurrently during execution, thereby optimizing performance.

Such a design significantly reduces wasted time and computing resource, increases overall processing capability of the system, and effectively handles complex heterogeneous graph structures.

According to a preferred embodiment, the steps for identifying central blocks by the block loading unit include: identifying meta-paths in the heterogeneous graph, and identifying a central vertex in the meta-path and designating the central vertex together with its directly connected adjacent vertices as a central block.

By identifying meta-paths and central vertices in the heterogeneous graph, the block loading unit efficiently identifies the central block to ensure higher specificity and effectiveness in their construction. This process reduces unnecessary computation and storage, and allows subsequent feature aggregation to be performed more precisely, thereby improving data locality.

According to a preferred embodiment, the block loading unit prioritizes the central blocks by: identifying the central vertex for each said central block and mapping each central block to a vertex in the block overlap graph; where two said central blocks share common vertices, creating an edge between the two central blocks, with an edge weight representing the number of said common vertices, the degree of overlap being defined as the number of the common vertices between the two central blocks; and sorting the central blocks according to degrees of overlap, such that central blocks with higher degrees are prioritized in computation. By constructing an overlap graph and calculating the degrees of overlap, the block loading unit sorts the central blocks intelligently with priority given to those having higher degrees of overlap, thereby reducing feature accesses between batches and improving feature reuse. This prioritization mechanism alleviates memory bandwidth pressure, and enhances overall processing efficiency.

According to a preferred embodiment, the system of the present disclosure comprises a block cache unit that comprises an aggregation buffer and a structure buffer, both connected to the reduction unit for data transmission. The aggregation buffer is configured to store final aggregation results for computational decoupling, wherein the structure buffer is configured to store intermediate results generated during structural aggregation to facilitate data loading. When the aggregation results in the aggregation buffer have been processed, the reduction unit transfers aggregation results from the structure buffer to the aggregation buffer for further processing, thereby ensuring continuity of processing.

By configuring an aggregation buffer and a structure buffer, the block cache unit achieves data decoupling during computation. Such data decoupling enables more efficient management of aggregation and intermediate results, reduces processing latency, ensures continuity of computation, and improves inference efficiency of HGNNs.

According to a preferred embodiment, the block scheduling unit is connected to the block cache unit. After a central block enters the structure buffer of the block cache unit, and when the number of vertices in the central block exceeds a maximum per-pass capacity of computing modules within a said processing unit, the block scheduling unit performs partitioning and assigns the resulting partitions to idle processing units. By reasonably partitioning central blocks and distributing the partitions to different processing units, the present disclosure balances computational load, avoids performance bottlenecks, and enhances processing efficiency, enabling faster inference.

According to a preferred embodiment, the reduction unit dynamically tracks status of each vertex, thereby indicating completion status of structural aggregation. An aggregation status flag is assigned to each vertex, when the aggregation status flag indicates that structural aggregation is in progress, the corresponding intermediate aggregation results are updated. When the aggregation status flag indicates that structural aggregation is complete, the structural features are transmitted to the structure buffer for semantic aggregation. And upon completion of semantic aggregation, semantic features are output from the structure buffer to an output buffer as final results.

By monitoring vertex states in real time, the reduction unit significantly improves the accuracy and efficiency of aggregation. When the aggregation of all relevant meta-paths is completed, semantic aggregation is promptly performed, thereby reducing redundant computations and improving overall system responsiveness.

According to a preferred embodiment, dynamically tracking the status of each vertex comprises: recording the number of central blocks in which each vertex participates during computation, wherein each central block is loaded only once. When a counter value corresponding to a vertex equals the number of central blocks to which the vertex belongs, it indicates that structural aggregation for the vertex in the current meta-path has been completed. Once this condition is satisfied for all relevant meta-paths of the vertex, semantic aggregation for the vertex is initiated. This computing approach reduces memory access frequency and increases computing speed by reusing intermediate aggregation results in registers. Accordingly, the reduction unit effectively supports complex heterogeneous graph operations, thereby enhancing the processing capability of the HGNN.

According to a preferred embodiment, each processing unit comprises: computing module(s) configured to perform the row-wise matrix multiplication and element-wise operations; and register(s) configured to store the weights and intermediate aggregation results for reuse during computation.

According to a preferred embodiment, the system of the present disclosure further comprises a control unit connected to the block loading unit, the block scheduling unit, the processing units, and the reduction unit, respectively, and configured to send control information to each unit so that they perform parallel execution. The control unit employs a coordination mechanism to ensure efficient collaboration among the processing units, thereby maximizing resource utilization and reducing inference time. This parallel execution mechanism significantly enhances the overall processing efficiency of the HGNN.

According to a preferred embodiment, the control unit is provided with a communication port, and the block loading unit is connected to off-chip memory. The off-chip memory transmits graph data to the HGNN acceleration system, where the data are processed by the various units and the results are fed back to the off-chip memory. The data stored in the off-chip memory include: meta-path instances, block overlap graph structures, graph structures, weight matrices, and vertex features.

The present disclosure provides, in a second aspect, a block-centric acceleration method for heterogeneous graph neural networks (HGNNs), which includes: identifying central blocks and constructing a block overlap graph, and prioritizing the central blocks according to degrees of overlap thereof, dynamically assigning the prioritized central blocks to idle processing units; performing computations on the central blocks based on row-wise matrix multiplication and element-wise operations to carry out hybrid computation for HGNN inference, thereby generating intermediate aggregation results corresponding to structural aggregation and semantic aggregation within the block overlap graph; and determining an aggregation status flag based on the intermediate aggregation results, and outputting semantic features upon completion of the structural aggregation and semantic aggregation.

According to a preferred embodiment, identifying the central blocks comprises: identifying meta-paths in a heterogeneous graph; and identifying a central vertex in the meta-path, and designating the central vertex together with its directly connected adjacent vertices as a central block.

According to a preferred embodiment, prioritizing the central blocks comprises: identifying the central vertex for each central block and mapping each central block to a vertex in the block overlap graph; where two said central blocks share common vertices, creating an edge between the two central blocks, with an edge weight representing the number of said common vertices, wherein the degree of overlap is defined as the number of the common vertices between the two central blocks; and sorting the central blocks according to degrees of overlap, such that central blocks with higher degrees are prioritized in computation.

According to a preferred embodiment, the method of the present disclosure further comprises the step of configuring a block cache unit that comprises an aggregation buffer and a structure buffer. The aggregation buffer is configured to store final aggregation results for computational decoupling, wherein the structure buffer is configured to store intermediate results generated during structural aggregation to facilitate data loading. When the aggregation results in the aggregation buffer have been processed, the aggregation results from the structure buffer are transferred to the aggregation buffer for further processing, thereby ensuring continuity of processing.

According to a preferred embodiment, after a central block enters the structural buffer of the block cache unit, and when the number of vertices in the central block exceeds a maximum per-pass capacity of computing modules within a said processing unit, partitioning is performed and the resulting partitions are assigned to idle processing units.

According to a preferred embodiment, the method of the present disclosure further comprises: dynamically tracking status of each vertex, thereby indicating completion status of structural aggregation; wherein an aggregation status flag is assigned to each vertex; when the aggregation status flag indicates that structural aggregation is in progress, the corresponding intermediate aggregation results are updated; when the aggregation status flag indicates that structural aggregation is complete, the structural features are transmitted to the structure buffer for semantic aggregation; and upon completion of semantic aggregation, semantic features are output from the structure buffer to an output buffer as final results.

According to a preferred embodiment, dynamically tracking the status of each vertex comprises: recording the number of central blocks in which each vertex participates during computation; wherein each said central block is loaded only once, and when a counter value corresponding to a vertex equals the number of central blocks to which the vertex belongs, it indicates that structural aggregation for the vertex in the current meta-path has been completed; and initiating semantic aggregation for the vertex once this condition is satisfied across all relevant meta-paths.

According to a preferred embodiment, the method of the present disclosure further comprises: performing row-wise matrix multiplication and element-wise operations; and storing weights and intermediate aggregation results for reuse during computation.

According to a preferred embodiment, when computing degrees of overlap of the central blocks, the central blocks with higher degrees are prioritized for processing, wherein the block overlap graph is traversed in depth-first order, and the central blocks are sorted according to edge weights in the heterogeneous graph, such that the higher the edge weight, the higher the processing priority assigned to the corresponding central block.

The present disclosure introduces a block-centric acceleration method that addresses challenges in current HGNN inference. In particular, identifying central blocks and constructing a block overlap graph reduces obstacles to feature reuse between adjacent batches, thereby increasing vertex feature reuse and enhancing data locality. By prioritizing central blocks with higher overlap degrees, the system optimizes feature aggregation, reduces unnecessary memory accesses, and lowers memory bandwidth consumption caused by redundant feature retrieval.

Additionally, a mechanism for dynamically allocating central blocks to idle processing units is implemented to improve the utilization efficiency of computational resources, thereby enabling multiple processing units to operate in parallel and further accelerating the inference process. With hybrid computing support, the processing units are capable of executing multiple computing tasks simultaneously, thereby enhancing the adaptability of the system to graphs with complex structures. By determining an aggregation status in real time, the system ensures rapid output of semantic features upon completion of both structural and semantic aggregation, thereby significantly improving the inference speed and efficiency of the HGNN. These measures effectively address inefficiencies in existing methods and provide robust support for efficient inference in HGNNs.

The present disclosure provides, in a third aspect, a processor based on a heterogeneous graph neural network (HGNN), wherein the processor is configured to execute the aforementioned method of the present disclosure.

### BRIEF DESCRIPTION OF THE DRAWINGS

FIG. 1 is a schematic diagram illustrating a simplified module connection relationship of a block-centric acceleration system for heterogeneous graph neural networks (HGNNs) according to the present disclosure;

FIG. 2 is a schematic diagram illustrating a meta-path of a heterogeneous graph according to the present disclosure;

FIG. 3 is a schematic diagram illustrating a heterogeneous graph inference model according to the present disclosure;

FIG. 4 is a schematic diagram illustrating a central block and a block overlap graph according to the present disclosure;

FIG. 5 is a schematic diagram illustrating a micro-architecture of a reduction unit according to the present disclosure; and

FIG. 6 is a schematic flowchart illustrating a block-centric acceleration method for heterogeneous graph neural networks (HGNNs) according to the present disclosure.

### DETAILED DESCRIPTION OF THE EMBODIMENTS

A detailed description is provided below with reference to the accompanying drawings.

### Embodiment 1

In the current process of heterogeneous graph neural network (HGNN) inference, certain challenges persist. On the one hand, existing feature aggregation methods are typically executed in accordance with the storage order of meta-path instances. This means that when inference is performed across different batches, few or even none of the vertex features can be reused, thereby reducing data locality and increasing unnecessary memory accesses.

On the other hand, since many meta-paths exhibit symmetrical properties, a vertex may serve as a starting point in some meta-paths while simultaneously functioning as an ending point in others. This property not only exacerbates the problem of redundant feature access but also significantly increases memory bandwidth consumption. More specifically, when the same vertex participates in information transmission through multiple meta-paths, repeated data read and write operations are incurred, thereby further elevating computational costs.

To alleviate these problems, it is necessary to optimize feature aggregation strategies and the design of data structures. For instance, improving the storage organization of meta-path instances or adopting more intelligent scheduling algorithms can enhance feature reuse and reduce the frequency of memory accesses. At the same time, identifying and merging different perspective representations of the same vertex can effectively reduce redundant computation and the associated memory bandwidth consumption. Such improvements not only boost the performance of HGNN models but also enable them to better meet the requirements of real-time analysis on large-scale heterogeneous graph datasets.

As described above, although existing HGNN frameworks have already demonstrated strong capability, their inference efficiency still requires improvement. Therefore, how to enhance the processing efficiency of HGNNs remains a pressing issue to be addressed.

The present disclosure provides a block-centric acceleration system and method for heterogeneous graph neural networks (HGNNs). The present disclosure further provides a processor 200 based on HGNNs, the processor 200 being configured to execute the block-centric acceleration method for HGNNs disclosed herein. Preferably, the present disclosure also provides a block-centric acceleration apparatus for HGNNs comprising the processor 200 and an off-chip memory 100. Preferably, the present disclosure further provides a storage medium storing program codes for executing the block-centric acceleration method for HGNNs.

Preferably, the processor 200 may be embodied as physical hardware capable of processing information, such as a CPU or an application-specific integrated circuit (ASIC). Preferably, the processor 200 may also be installed in a server, a cloud server, or a similar device.

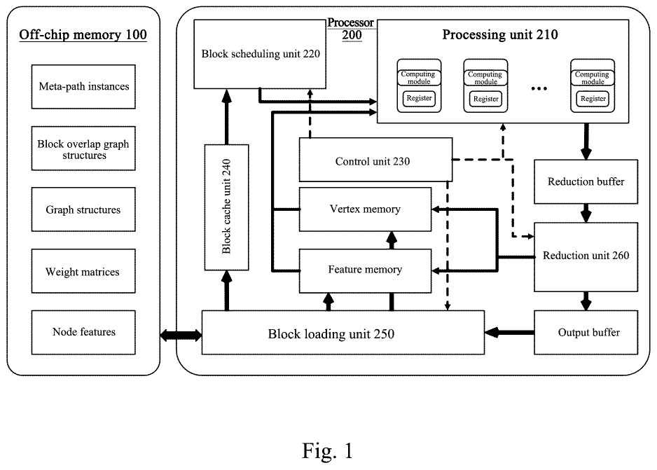

As illustrated in FIG. 1, a block-centric acceleration system for HGNNs comprises a processor 200. The processor 200 comprises a block loading unit 250, a block scheduling unit 220, processing units 210, and a reduction unit 260. Preferably, the system further comprises a control unit 230.

As shown in FIG. 1, the control unit 230 is connected to the block loading unit 250, the block scheduling unit 220, the processing units 210, and the reduction unit 260, respectively, and is configured to send control information to each of these units so that they execute in parallel. The control unit 230 is provided with a communication port, which serves as the communication unit of the present disclosure.

The block loading unit 250 is connected to external devices, such as the off-chip memory 100. The off-chip memory 100 is configured to store graph data and functions as storage unit of the present disclosure. After the graph data are transmitted from the off-chip memory 100 to the HGNN acceleration system, they are processed by the various units and finally fed back to the off-chip memory 100. As illustrated in FIG. 1, the off-chip memory 100 stores: meta-path instances, block overlap graph structures, graph structures, weight matrices, and vertex features.

According to a preferred embodiment, the system further comprises a block cache unit 240. The block cache unit 240 comprises an aggregation buffer and a structure buffer. Both the aggregation buffer and the structure buffer are connected to the reduction unit 260 to establish data transmission relationships.

As shown in FIG. 1, the block loading unit 250 and the block cache unit 240 are connected for data transmission. The block cache unit 240 and the block scheduling unit 220 are connected for data transmission. The block scheduling unit 220 and the processing units 210 are connected for data transmission. The processing units 210 and the reduction unit 260 are connected for data transmission. Preferably, the processor 200 further comprises a reduction buffer and an output buffer. In terms of data transmission, the reduction buffer is disposed between the processing units 210 and the reduction unit 260. The output buffer is connected to both the reduction unit 260 and the block loading unit 250 for data transmission. The reduction buffer is configured to store intermediate results generated from multiple aggregation computations on the same vertex by various computing modules. Such intermediate results include vertex indices, features, weights, and timestamps, thereby ensuring stability in data transmission and improving processing efficiency. The output buffer is configured to store the final aggregation results output by the reduction unit 260. The output buffer ensures that the final results are efficiently delivered from the accelerator to subsequent processing stages, thereby enhancing the stability of data transmission within the graph computation system and reducing communication latency.

The block loading unit 250 is configured to identify central blocks and construct a block overlap graph, and to prioritize the central blocks based on their degrees of overlap.

The block scheduling unit 220 is configured to dynamically assign the prioritized central blocks to idle processing units 210.

The processing units 210 are configured to perform computations on the central blocks based on row-wise matrix multiplication and element-wise operations, thereby carrying out hybrid computation for HGNN inference. In doing so, the processing units generate intermediate aggregation results corresponding to structural aggregation and semantic aggregation within the block overlap graph.

The reduction unit 260 is configured to determine an aggregation status flag according to the intermediate aggregation results received from the processing units 210, and to output semantic features upon completion of both structural aggregation and semantic aggregation.

The core concept of the block-centric acceleration method for HGNNs disclosed herein is as follows.

Within each meta-path, one or more central vertices can be identified, typically characterized by dense connections with multiple adjacent vertices. For example, in a user-item-user meta-path, the user vertex may be regarded as a central vertex. All adjacent vertices directly connected to the central vertex are grouped into a central block, which enables concentrated access to the features of these vertices during processing and reduces latency caused by random memory accesses.

Aggregation is then performed on each central block, whereby the information of all adjacent vertices is used to compute the aggregated features of the central vertex. This approach allows the central vertex to act as both a starting point and an ending point in the computation, thereby avoiding redundant feature acquisition arising from structural symmetry. By limiting the scope of each computation and focusing on localized datasets, this method enhances feature access locality, increases the likelihood of data reuse, and thereby greatly improves computational efficiency and overall system performance.

Some principal terms used herein are explained below.

Central block: A block is defined by identifying a vertex located at the center of a given meta-path and grouping it together with its adjacent vertices. For example, in an L-hop meta-path v0, v1, . . . , vL, the three consecutive vertices v(L/2−1), v(L/2), and v(L/2+1) collectively constitute a central block. Unless otherwise specified, all subsequent references to “blocks” pertain to central blocks.

Block overlap graph: A block overlap graph is represented as a weighted undirected graph, in which each vertex corresponds to a central block. The weight W of an edge between two central blocks denotes the number of overlapping vertices between them.

Intra-block non-redundant aggregation: The graph is partitioned into several central blocks based on the central vertices along each meta-path. Structural aggregation is initially performed within each central block. In the case of symmetric meta-paths, each vertex may act both as a starting vertex and an ending vertex. In such scenarios, updates of the same vertex's features across different central blocks are consolidated, thereby completing the structural aggregation without redundant computations.

Inter-block overlap-driven processing: To exploit overlapping vertices among meta-paths, central blocks are activated in a depth-first search order on the block overlap graph. When a central block is selected, it is first marked as visited, and then the unvisited adjacent block with the maximum edge weight is chosen. This process is repeated until all adjacent central blocks have been visited.

The block-centric acceleration method for HGNNs of the present disclosure is described in detail below.

The block loading unit 250 is configured to identify meta-paths in a heterogeneous graph.

A meta-path sampling module is integrated in the block loading unit 250 to traverse the heterogeneous graph structural data and detect meta-paths therein. Preferably, a meta-path is defined as a sequence of edges connecting a source vertex type to a target vertex type.

The block loading unit 250 loads the block overlap graph from a high-bandwidth memory (HBM) in the off-chip memory 100 into the on-chip memory. By employing multiple data loading hardware pipelines, the block loading unit 250 identifies central blocks based on the block overlap graph and prioritizes these central blocks accordingly.

Specifically, the block loading unit 250 reads the vertices within each central block, employs the vertex index as an offset to the base address of the vertex features, and loads the corresponding features into the block cache unit 240. The block loading unit 250 further adopts a double-buffering mechanism to overlap the data loading of all buffers with subsequent computations.

As shown in FIG. 1, the vertex memory is configured to temporarily store structural information of the graph, including vertices and their connectivity. The feature memory is configured to temporarily store vertex feature data, which serve as the required input data during graph neural network (GNN) inference. The vertex memory and feature memory receive intermediate results transmitted from the reduction unit 260 after aggregation, and the temporarily stored data are further fed into the computing modules for subsequent iterations of loop feedback.

The block loading unit 250 identifies the central vertex of a meta-path and determines all adjacent vertices directly connected to the central vertex as a central block.

For each central vertex v, all adjacent vertices N(v) are first identified. The features of these adjacent vertices can be represented as {hu|u∈N(v)}, where hu denotes the feature vector of vertex u.

Common aggregation methods include summation, mean, or max pooling. In the present disclosure, the mean aggregation method is selected. The computation formula is expressed as:

$${hv}^{′} = \frac{1}{\vert N ( v ) \vert} {\sum }_{u ∈ N ( v )} hu .$$

The aggregated feature vector hv′ is further processed through a nonlinear activation function Sigmoid, whose output is used to update the central vertex v.

The nonlinear activation function Sigmoid is expressed as:

$${hv}^{″} = \frac{1}{1 + {e}^{- {hv}^{′}}} ,$$

where hv″ denotes the updated activation value of the aggregated feature vector after Sigmoid processing.

Preferably, the block loading unit 250 utilizes hardware pipelines to determine the priority order of central blocks. This process consists of four stages: block allocation, offset acquisition, neighbor acquisition, and block selection. A traversal finite state machine (FSM) manages the entire process to ensure high execution efficiency. The data loading hardware pipeline architecture seamless transitions across the stages, thereby optimizing the central block selection process.

Additionally, the block loading unit 250 integrates two access mechanisms, namely a bit vector access block and an array access block. The bit vector access block is used for fast querying of block states or attribute indicators, while the array access block handles complex data structures or contiguous data sequences associated with specific blocks. Together, these mechanisms enable flexible operations and performance optimization of the block loading unit 250 under different application scenarios.

The bit vector access block stores the accessed blocks, whereas the array access block records the most recently processed block.

In the initial block allocation phase, the root block is directly retrieved from the HBM in the off-chip memory 100 and marked as “1” in the bit vector access block. Here, the root block denotes the starting central block after partitioning the graph, serving as the starting point for subsequent computations and aggregation.

During the offset acquisition stage, the block overlap graph is used to obtain the start and end offsets of central blocks connected to the root block.

In the neighbor acquisition stage, the adjacent blocks of the root block are retrieved from the block overlap graph.

During the central block selection stage, the central block not yet processed with the maximum edge weight is selected and pushed into the block cache unit 240.

When no unvisited central blocks remain, the aforementioned hardware pipelines are triggered to utilize central blocks across different meta-paths. In the block allocation stage, the central vertex of the most recently processed central block is retrieved from the array access block. In the offset acquisition stage, the start and end offsets of the central vertex are obtained from the heterogeneous graph data. In the neighbor acquisition stage, the adjacent vertices of the central vertex are retrieved. Finally, in the block selection stage, the first central block not yet processed corresponding to these adjacent vertices is selected. For the block loading unit 250, the only distinction lies in whether the input data are derived from the block overlap graph or the heterogeneous graph, while the overall architecture remains consistent, thereby conserving hardware resources.

Specifically, the block loading unit 250 prioritizes the central blocks through the following steps:
S100: Construction of the block overlap graph. The block loading unit 250 determines the central vertex of each central block and map each central block to a vertex in the overlap graph. When two central blocks share common vertices, an edge is created between them, and the weight of the edge represents the number of the common vertices. Accordingly, the overlap degree between two central blocks is defined as the number of common vertices contained in both blocks, thereby quantifying both the overlap relationship and the extent of overlap among the central blocks.
S200: Traversal of the block overlap graph and ordering of central blocks. The central blocks are ordered based on their overlap degrees. Central blocks with higher overlap degrees are prioritized in computation, thereby improving data locality.

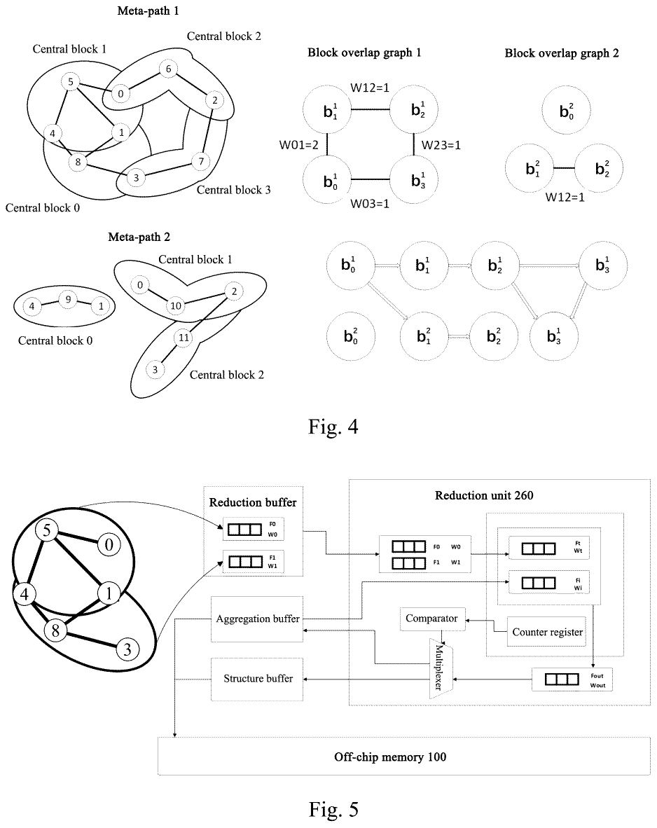

Preferably, the term “common vertex” refers to the identical vertex included in two central blocks. As shown in FIG. 4, for example, the common vertex between Central block 2 and Central block 3 in Meta-path 1 is Vertex 2. Preferably, the overlap degree is defined as the number of common vertices shared between two central blocks, which can be expressed as:

$$W 01 = \vert {b}_{0}^{1} ⋂ {b}_{1}^{1} \vert ,$$

where

$${b}_{0}^{1}$$

denotes Central block 0 in Meta-path 1, and

$${b}_{1}^{1}$$

denotes Central block 1 in Meta-path 1.

When performing the overlap degree calculation, the block loading unit 250 prioritizes the central blocks with higher overlap degrees for processing. By traversing the block overlap graph in a depth-first order, the block loading unit 250 sorts the central blocks according to the edge weights. The larger the edge weight, the higher the computation priority assigned to the corresponding central block.

Preferably, the term “depth-first order” refers to the depth-first search (DFS) algorithm in graph traversal. This algorithm starts from an initial vertex and explores as far as possible along each branch until a leaf vertex is reached or no unvisited adjacent vertices remain, after which the algorithm backtracks to the most recent branching point (that is, the last vertex having unvisited adjacent vertices) to continue exploration. Since the block overlap graph can be regarded as a graph in which each central block corresponds to a vertex, traversing the central blocks is equivalent to traversing the vertices of the block overlap graph. Therefore, DFS can be employed to perform such traversal. During DFS, the algorithm prioritizes the adjacent central block connected by the edge with the maximum weight as the next central block to be processed.

This selection strategy ensures that, when a central block is processed, the results of previous computations can be readily reused, thereby reducing the number of memory accesses. In central block processing, DFS guarantees that when a central block is accessed, its unprocessed adjacent central blocks are prioritized for access, thus maximizing data locality and reuse.

The block loading unit 250 transmits the central blocks to the block cache unit 240 in a depth-first order. The block cache unit 240 temporarily buffers the ordered central blocks and transfers the final results obtained from the reduction unit 260 to the output buffer.

The block cache units 240 serve as coordinators between the computing modules and the storage units, ensuring smooth data flow during computation and avoiding computational bottlenecks caused by data transfer delays. They also reduce frequent access of the computing modules to external memory, thereby improving overall system efficiency and response speed.

The aggregation buffer within the block cache unit 240 is used to store the final aggregation results for computational decoupling. The structure buffer in the block cache unit 240 is used to store the intermediate results of structural aggregation for data loading. When the aggregation results in the aggregation buffer have been processed, the reduction unit 260 transfers the aggregation results from the structure buffer to the aggregation buffer for processing, ensuring the continuity of the workflow.

The interconnection of the aggregation buffer and the structure buffer within the block cache unit 240 with the reduction unit 260 represents a unique system architecture of the present disclosure, in which data loading is decoupled from computation. While computation is performed in the aggregation buffer, the structure buffer can simultaneously perform data loading, thereby effectively hiding memory access latency.

Specifically, the reduction unit 260 connects to the two key buffers: the aggregation buffer and the structure buffer. The aggregation buffer is mainly used to store the final aggregation results. After structural aggregation is completed, the results are transferred to the structure buffer for subsequent semantic aggregation. The structure buffer, in turn, is dedicated to storing intermediate results generated during structural aggregation. Whenever a vertex completes its structural aggregation, the result is stored into the structure buffer for subsequent use.

Once the data in the aggregation buffer are processed, the reduction unit 260 transfers the results stored in the structure buffer into the aggregation buffer for further processing. This seamless transition mechanism ensures continuity of the entire workflow and minimizes latency to the greatest extent possible.

Upon completion of data processing in the block cache unit 240, the block scheduling unit 220 dynamically schedules new data-loading and processing tasks based on the central blocks currently being processed and the status of the processing units 210. This ensures that the required computation data are made available in a timely manner, thereby optimizing processing efficiency and reducing waiting time. Such a design not only maintains smooth data flow but also enhances overall system responsiveness and computational performance.

Once the central blocks are input into the block cache unit 240 by the block loading unit 250, the block scheduling unit 220 dynamically assigns the ordered central blocks to available processing units 210. That is, after a central block enters the structure buffer of the block cache unit 240, if the number of vertices in the central block exceeds the maximum per-pass capacity of the computing modules within a processing unit 210, the block scheduling unit 220 performs partitioning and assigns the resulting partitions to different idle processing units 210.

When the number of vertices contained in a central block exceeds the processing capability of the computing modules, the block scheduling unit 220 partitions the central block and dispatches the resulting partitions to multiple computing modules. The block scheduling unit 220 first analyzes the size of the current central block, determines its vertex count and the required computational resources, and establishes a threshold based on the maximum number of vertices that can be processed by the computing modules. If the vertex count of the central block exceeds this threshold, the block is evenly partitioned into several sub-blocks with approximately equal numbers of vertices. For example, if the central block contains 100 vertices while the threshold is set to 20, the block can be divided into five sub-blocks.

Partitioning central blocks according to their size and the computational capability of the computing modules accelerates overall execution, ensures balanced workload distribution, and provides flexibility in handling central blocks of varying sizes.

Preferably, as shown in FIG. 1, each processing unit 210 is equipped with computing module(s) and register(s). The computing module is configured to perform row-wise matrix multiplications and element-wise operations. The register is configured to store weights and intermediate aggregation results for reuse during computation. As illustrated in FIG. 1, each computing module is paired with one register. The block scheduling unit 220 first transmits data into multiple registers within the computing module; the data are then transferred from the registers to the computing module for computation, and finally output from the computing module after processing.

Row-wise matrix multiplication refers to multiplying a row of first matrix with a column of second matrix and accumulating the results to generate one element of an output matrix. Element-wise operations refer to applying an operation (e.g., addition, subtraction, or multiplication) between corresponding elements of two matrices or vectors of the same dimensions, thereby producing a new matrix or vector.

When a processing unit 210 is initialized, it first retrieves the required weights from the off-chip memory 100 and loads them into the internal registers. This preloading mechanism allows subsequent computations to directly reuse the register-stored data, thereby avoiding frequent accesses to the slower off-chip memory. Once the weights are prepared, the computing module reads the necessary data from the registers and performs the corresponding row-wise matrix multiplications or element-wise operations as required by the algorithm. Any intermediate results generated in this process are also temporarily stored in the registers for later use. This design not only improves computational efficiency but also reduces delays caused by unnecessary data transfers.

As shown in FIG. 3, HGNN inference typically consists of four distinct stages:
(1) Meta-path generation: identifying all instances that match the predefined meta-paths;
(2) Feature projection: transforming vertex features of various dimensions into a common feature space;
(3) Structural aggregation: encoding the vertex features from each meta-path instance starting from vertex v into a single feature vector, and then aggregating these encoded vectors to capture structural information; and
(4) Semantic aggregation: further aggregating the structural features of vertex v across different types of meta-paths to obtain semantic information.

Preferably, these stages of HGNN inference are executed by the processing units 210. The reduction unit 260 receives intermediate aggregation results from the processing units 210 and checks the aggregation status of the vertex to determine whether the results should be updated to the aggregation buffer or transferred to the structure buffer.

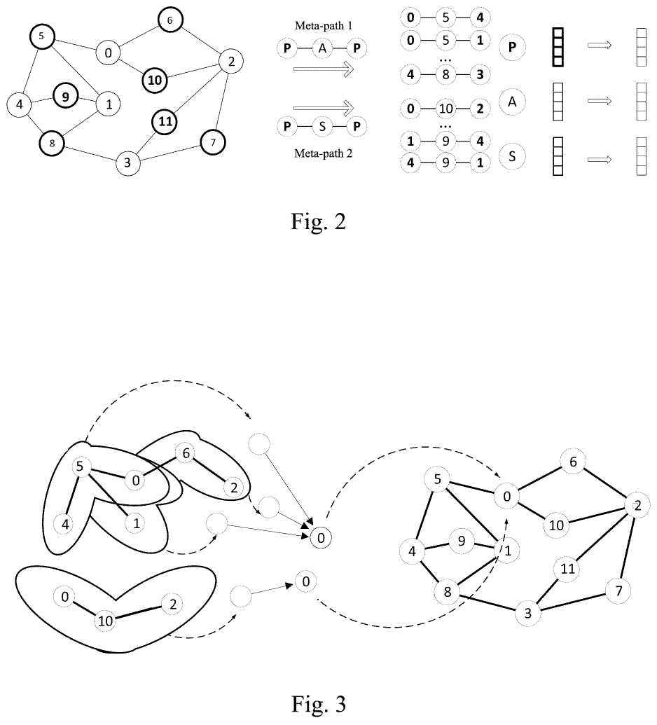

In FIG. 2 and FIG. 3, the numerals denote the indices of the respective vertices v. As shown, when processing Meta-path 1, the meta-path instances originating from vertices v1 and v4 involve the same vertex set, namely {v0, v1, v3, v4, v5, v8}. In parallel execution of multiple meta-paths, five vertices {v0, v1, v2, v3, v4} are shared between Meta-path 1 and Meta-path 2. However, due to sequential storage, path-centric execution may cause redundant reloads of vertex features, leading to situations where the same vertex features are processed only after long intervals.

Because of the inherent structural symmetry of most meta-paths, the starting vertex of one meta-path inevitably serves as the ending vertex of another, thereby inducing symmetry-related redundant feature accesses. Specifically, let N(v) denote the set of neighbors of a vertex v within a meta-path. Then v appears in 2|N(N(v))| meta-path instances, where N(N(v)) represents the second-order neighbors of v, i.e., all vertices connected to neighbors of v, and |N(N(v))| denotes the size of this set, i.e., the number of those second-order neighbors. Among these instances, |N(N(v))| occur with v as the starting vertex and |N(N(v))| with v as the ending vertex. Aggregations with v as the starting vertex are highly localized, whereas aggregations with v as the ending vertex are widely scattered. For instance, assuming the graph in FIG. 2 is large and vertices v0 and v4 are processed at different time intervals such that the cache cannot persistently retain the features of v0, then when computing [symbol] v0, v4 [symbol] with v0 as the starting vertex, followed later by [symbol] v4, v0 [symbol] with v4 as the starting vertex, the feature of v0 must be reloaded.

FIG. 4 illustrates the construction of a block overlap graph based on central blocks. As shown, for an L-hop meta-path v0, v1 . . . vL, the middle vertex vL/2 is treated as the central vertex. For three consecutive vertices vL/2−1, vL/2, vL/2+1, where vL/2−1 and vL/2+1 are neighbors of vL/2, all neighbors of vL/2 are grouped into a central block indexed by this central vertex. In FIG. 4, Block 0 of Meta-path 1 includes the set {v1, v3, v4} and is indexed by central block v8. The block overlap graph is defined as a weighted undirected graph, where each vertex corresponds to a central block. An edge exists between two central blocks if they share common vertices. The weight W of an edge represents the number of overlapping vertices shared between two central blocks. For example, if

$${b}_{0}^{1} ⋂ {b}_{1}^{1} = \{ v 1 , v 4 \} ,$$

then the weight W01 of the edge between central blocks

$${b}_{0}^{1} and {b}_{1}^{1}$$

is expressed as:

$$W 01 = \vert {b}_{0}^{1} ⋂ {b}_{1}^{1} \vert = 2.$$

FIG. 4 illustrates the method of the present disclosure by means of a simplified example. Based on the central vertex of each meta-path, the graph is partitioned into several central blocks. Structural aggregation is first performed within these central blocks. When the meta-path is symmetric, each vertex is computed both as a starting vertex and an ending vertex. Thereafter, the same vertex appearing in different central blocks is updated accordingly, thereby completing structural aggregation.

By way of example, in Block

$${b}_{1}^{1} ,$$

Vertex v0 simultaneously functions as the starting vertex for the computation of [symbol] v0, v1 [symbol] an [symbol] v0, v4 [symbol] , and as the ending vertex for the computation of [symbol] v1, v0 [symbol] and [symbol] v4, v0 [symbol] . Upon completion of computations in Blocks

$${b}_{1}^{1} and {b}_{2}^{1} ,$$

the features of v0 are further updated across both blocks to derive the final structural features. These structural features constitute intermediate representations for each vertex, which are subsequently used as inputs to the semantic aggregation phase. Each meta-path originating from v is assigned to |N(v)| central blocks. Each of these blocks has a distinct central vertex, thereby enabling more concentrated and repeated utilization of vertex features. Such a mechanism stands in contrast to common path-centric execution, in which vertex features are dispersed across |N(N(v))| meta-path instances and accessed in a random manner, significantly increasing the computational burden and introducing redundancy due to symmetry.

As illustrated in FIG. 4, in order to efficiently utilize overlapping vertices and update the same vertex across different central blocks, the central blocks are processed in a depth-first traversal order based on the block overlap graph. When a central block is selected, the computing module marks it as visited to avoid redundant processing. Subsequently, the module searches for the unvisited adjacent central block with the maximum edge weight. This process is iteratively performed until no further unvisited adjacent blocks remain. Assuming that Blocks

$${b}_{0}^{1} and {b}_{0}^{2}$$

are concurrently processed at the beginning, the processing order for Meta-path 1 follows

$$\{ {b}_{0}^{1} , {b}_{1}^{1} , {b}_{2}^{1} , {b}_{3}^{1} \} ,$$

while no unvisited blocks are adjacent to

$${b}_{0}^{2} .$$

To identify the next block with the most reusable vertices, the system searches within central blocks of different meta-paths. The closer to the central vertex, the greater the overlap tends to be. Thus, the present disclosure refers to the central vertex of the most recently processed block (i.e., v8 of

$${b}_{0}^{1}$$

in pipeline #1), and searches for Meta-path 2 blocks whose central vertices lie within one-hop or two-hop neighbors of v8 (i.e., v9 and v11). Since Block

$${b}_{0}^{2}$$

with Central vertex v9 has already been visited, Block

$${b}_{2}^{2}$$

with Central vertex v11 is prioritized as the next target
for pipeline #2. If Meta-path 2 completes computation after Block

$${b}_{1}^{2}$$

while Meta-path 1 is still processing Block

$${b}_{2}^{1} ,$$

### Block

$${b}_{3}^{1}$$

is reassigned to pipeline #2 to balance the workload.

According to a preferred embodiment, the reduction unit 260 dynamically tracks the states of vertices, thereby indicating the completion status of structural aggregation.

The reduction unit 260 receives aggregation results from the processing units 210 and monitors whether each vertex has completed structural aggregation or semantic aggregation. Preferably, the reduction unit 260 assigns an aggregation status flag to each vertex. When the aggregation status flag indicates that structural aggregation is in progress, the reduction unit 260 updates the corresponding intermediate results. Once the aggregation status flag indicates that structural aggregation is complete, the structural features are transmitted to a structure buffer for semantic aggregation. When semantic aggregation is complete, the corresponding semantic features are output from the structure buffer to the output buffer as the final results.

Preferably, as illustrated in FIG. 5, the reduction unit 260 is provided with a counter register and a comparator. The count register is used to store the aggregation count for each vertex. The comparator is used to determine whether the number of completed aggregations equals the number of central blocks associated with the vertex.

Specifically, in the present disclosure, a multiplexer is inserted downstream of the comparator. If the comparator result is true, the multiplexer forwards the data to the structure buffer for semantic aggregation. Otherwise, the data are routed to the aggregation buffer for further updating.

The counter register records the number of central blocks in which each vertex participates during computation. Since each central block is loaded only once, when the counter value of a vertex equals the number of central blocks it belongs to, this indicates that structural aggregation for the vertex in the current meta-path has been completed. When this condition is satisfied for all meta-paths associated with the vertex, semantic aggregation begins.

Preferably, since the same vertex may appear in multiple central blocks during aggregation, the reduction unit 260 is configured to efficiently update aggregation results across multiple central blocks in order to obtain the final structural features.

For example, the reduction unit 260 assigns an aggregation status flag to each vertex to record its status, indicating whether the vertex is undergoing structural aggregation. In the present embodiment, “0” indicates structural aggregation is in progress, while “1” indicates structural aggregation has been completed and the vertex is ready for semantic aggregation.

FIG. 5 illustrates a processing example of the reduction unit 260.

First, for the central block associated with vertex v1, structural aggregation is independently performed within the block to obtain intra-block features (F0, F1) and corresponding weights (W0, W1), which are stored in the reduction buffer. Each entry in the reduction buffer is structured as <vertex index, feature, weight, timestamp>. Entries are replaced once their timestamp expires. All entries with the same vertex index are transmitted to the reduction unit 260 for inter-block aggregation to update the results. This approach leverages the aforementioned overlap-driven processing to ensure that the same vertex is typically processed in a timely manner, even across different central blocks. Therefore, the data in the reduction buffer can be updated first without data dependency. Meanwhile, this reduces the overhead of repeatedly transferring previously aggregated results to the aggregation buffer for further updates. Finally, the reduction unit 260 further updates results Ft and Wt using the previously aggregated features Fi and weights Wi. Once computation for a vertex is complete, the output feature Fout must be normalized by dividing it by the output weight Wout. The result update is implemented by means of a parallel adder tree.

### Embodiment 2

The present embodiment is a further refinement of Embodiment 1, and repetitive content will not be described again.

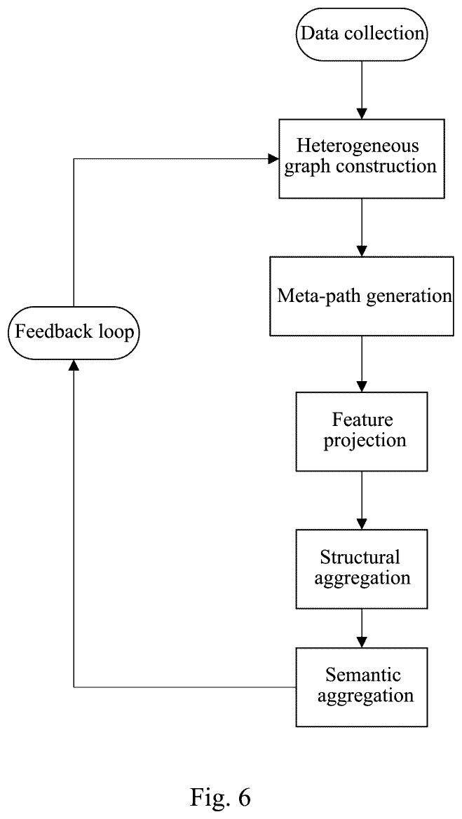

A case is provided herein to illustrate the method of the present disclosure, as shown in FIG. 6.

On modern e-commerce platforms, personalized recommendation systems can significantly improve user experience and increase sales conversion rates. By analyzing the complex relationships between users and items, the systems can provide accurate recommendations, thereby increasing users' purchase intentions.

### S1: Data Collection.

User behavior data cover various user activities on the platform, including browsing history, purchase records, wishlists, ratings, and so forth. Item feature data include product attributes, such as category, brand, price, user tags, and reviews.

### S2: Heterogeneous Graph (HG) Construction.

Users and items are represented as vertices. Different types of edges (such as “browse”, “purchase”, and “review”) connect them, thereby constructing a heterogeneous graph.

### S3: Meta-Path Generation.

Multiple meta-paths are designed according to business requirements. For example, “User-Item-User” reflects user influence via shared items, whereas “User-Item-Category” reflects the impacts of item categories. Each meta-path encodes a distinct pattern of relationships, enabling the system to capture complex interactions.

### S4: Feature Projection.

User and item features are projected into a shared feature space using embedding techniques, generating low-dimensional vectors. This allows features of different vertex types to be processed in a unified manner.

### S5: Structural Aggregation.

A center-block aggregation method identifies central vertices (e.g., users or items) in meta-paths and groups their adjacent vertices (e.g., items purchased by a user) into corresponding center blocks. Redundancy-free aggregation within each center block reduces unnecessary feature accesses and enhances computational efficiency.

### S6: Semantic Aggregation.

Multi-layer aggregation integrates structural features from different meta-paths to generate the final user and item representations. This method captures richer semantic information for generating personalized recommendation lists. The aggregated features combine historical behaviors with the preferences of similar users, supporting diverse recommendation strategies.

### S7: Feedback Loop.

The system collects feedback (e.g., clicks, purchases, and ratings) on the recommendations and uses it to further optimize the recommendation model. These feedback data are reintegrated into the heterogeneous graph, forming a closed loop that continuously improves recommendation accuracy.

The present disclosure significantly reduces redundant feature accesses through center-block aggregation, thereby enhancing data processing efficiency and reducing memory bandwidth demands. The overlap-driven mechanism ensures repeated use of similar features in short intervals, while optimized access patterns reduce external memory operations and power consumption. Especially in large-scale data processing, the energy efficiency ratio is significantly improved. By leveraging effective feature aggregation and rich meta-path information, the system can provide more personalized and accurate recommendations, thereby improving user satisfaction and platform sales conversion. Moreover, the system can promptly respond to user feedback and update recommendations in real time, greatly enhancing the user experience.

It should be noted that the embodiments described above are exemplary. Those skilled in the art, inspired by the present disclosure, may devise various solutions within the disclosed scope, all of which fall within the protection of the present application. It should also be understood that the specification and accompanying drawings provided herein are illustrative and not restrictive of the appended claims. The protection scope of the present application is defined by the appended claims and their equivalents. The specification provided herein encompasses multiple inventive concepts, and phrases such as “preferably” or “according to a preferred embodiment” indicate distinct inventive concepts. The applicant reserves the right to file divisional applications for each inventive concept.

What is claimed is:

1. A block-centric acceleration system for heterogeneous graph neural networks (HGNNs), the system comprising a processor, the processor comprising:
a block loading unit, configured to identify central blocks and construct a block overlap graph so as to prioritize the central blocks according to their degrees of overlap;
a block scheduling unit, configured to dynamically assign the prioritized central blocks to idle processing units;
processing units, configured to perform computations on the central blocks based on row-wise matrix multiplication and element-wise operations, thereby performing hybrid computation for HGNN inference to generate intermediate aggregation results corresponding to structural aggregation and semantic aggregation within the block overlap graph; and
a reduction unit, configured to determine an aggregation status flag based on the intermediate aggregation results received from the processing units, and to output semantic features upon completion of the structural aggregation and semantic aggregation.

2. The system of claim 1, wherein the block loading unit identifies the central block by:
identifying meta-paths in a heterogeneous graph; and
identifying a central vertex in the meta-path and designating the central vertex together with its directly connected adjacent vertices as a central block.

3. The system of claim 2, wherein the block loading unit prioritizes the central blocks by:
identifying the central vertex for each said central block and mapping each central block to a vertex in the block overlap graph;
where two said central blocks share common vertices, creating an edge between the two central blocks, with an edge weight representing the number of the common vertices, the degree of overlap being defined as the number of the common vertices between the two central blocks; and
sorting the central blocks according to degrees of overlap, such that central blocks with higher degrees are prioritized in computation.

4. The system of claim 3, further comprising a block cache unit that comprises an aggregation buffer and a structure buffer, both connected to the reduction unit for data transmission,
the aggregation buffer being configured to store final aggregation results for computational decoupling;
the structure buffer being configured to store intermediate results generated during structural aggregation to facilitate data loading;
wherein, when the aggregation results in the aggregation buffer have been processed, the reduction unit transfers aggregation results from the structure buffer to the aggregation buffer for further processing, thereby ensuring continuity of processing.

5. The system of claim 4, wherein the block scheduling unit is connected to the block cache unit,
wherein, after a central block enters the structure buffer of the block cache unit, and when the number of vertices in the central block exceeds a maximum per-pass capacity of computing modules within a said processing unit, the block scheduling unit performs partitioning and assigns the resulting partitions to idle processing units.

6. The system of claim 5, wherein the reduction unit dynamically tracks status of each vertex, thereby indicating completion status of structural aggregation;
wherein an aggregation status flag is assigned to each vertex;
when the aggregation status flag indicates that structural aggregation is in progress, the corresponding intermediate aggregation results are updated;
when the aggregation status flag indicates that structural aggregation is complete, the structural features are transmitted to the structure buffer for semantic aggregation; and
upon completion of semantic aggregation, semantic features are output from the structure buffer to an output buffer as final results.

7. The system of claim 6, wherein dynamically tracking the status of each vertex comprises:
recording the number of central blocks in which each vertex participates during computation;
wherein each said central block is loaded only once, and when a counter value corresponding to a vertex equals the number of central blocks to which the vertex belongs, it indicates that structural aggregation for the vertex in the current meta-path has been completed; and
initiating semantic aggregation for the vertex once this condition is satisfied across all relevant meta-paths.

8. The system of claim 7, wherein each processing unit comprises:
computing module(s), configured to perform the row-wise matrix multiplication and element-wise operations; and
register(s), configured to store the weights and intermediate aggregation results for reuse during computation.

9. The system of claim 8, further comprising a control unit,
the control unit being connected to the block loading unit, the block scheduling unit, the processing units, and the reduction unit, respectively, and configured to send control information to each of these units so that they perform parallel execution.

10. The system of claim 9, wherein the control unit is provided with a communication port, and the block loading unit is connected to off-chip memory,
wherein graph data are transmitted from the off-chip memory to the HGNN system, processed by the various units, and results are fed back to the off-chip memory, and
wherein the data stored in the off-chip memory include: meta-path instances, block overlap graph structures, graph structures, weight matrices, and vertex features.

11. A block-centric acceleration method for heterogeneous graph neural networks (HGNNs), the method comprising:
identifying central blocks and constructing a block overlap graph, and prioritizing the central blocks according to degrees of overlap thereof,
dynamically assigning the prioritized central blocks to idle processing units;
performing computations on the central blocks based on row-wise matrix multiplication and element-wise operations to carry out hybrid computation for HGNN inference, thereby generating intermediate aggregation results corresponding to structural aggregation and semantic aggregation within the block overlap graph; and
determining an aggregation status flag based on the intermediate aggregation results, and outputting semantic features upon completion of the structural aggregation and semantic aggregation.

12. The method of claim 11, wherein identifying the central blocks comprises:
identifying meta-paths in a heterogeneous graph; and
identifying a central vertex in the meta-path, and designating the central vertex together with its directly connected adjacent vertices as a central block.

13. The method of claim 12, wherein prioritizing the central blocks comprises:
identifying the central vertex for each central block and mapping each central block to a vertex in the block overlap graph;
where two said central blocks share common vertices, creating an edge between the two central blocks, with an edge weight representing the number of the common vertices, the degree of overlap being defined as the number of the common vertices between the two central blocks; and
sorting the central blocks according to degrees of overlap, such that central blocks with higher degrees are prioritized in computation.

14. The method of claim 13, further comprising configuring a block cache unit that comprises an aggregation buffer and a structure buffer;
the aggregation buffer being configured to store final aggregation results for computational decoupling;
the structure buffer being configured to store intermediate results generated during structural aggregation to facilitate data loading;
wherein, when the aggregation results in the aggregation buffer have been processed, the aggregation results from the structure buffer are transferred to the aggregation buffer for further processing, thereby ensuring continuity of processing.

15. The method of claim 14, wherein after a central block enters the structural buffer of the block cache unit, and when the number of vertices in the central block exceeds a maximum per-pass capacity of computing modules within a said processing unit, partitioning is performed and the resulting partitions are assigned to idle processing units.

16. The method of claim 15, further comprising:
dynamically tracking status of each vertex, thereby indicating completion status of structural aggregation;
wherein an aggregation status flag is assigned to each vertex;
when the aggregation status flag indicates that structural aggregation is in progress, the corresponding intermediate aggregation results are updated;
when the aggregation status flag indicates that structural aggregation is complete, the structural features are transmitted to the structure buffer for semantic aggregation; and
upon completion of semantic aggregation, semantic features are output from the structure buffer to an output buffer as final results.

17. The method of claim 16, wherein dynamically tracking the status of each vertex comprises:
recording the number of central blocks in which each vertex participates during computation;
wherein each said central block is loaded only once, and when a counter value corresponding to a vertex equals the number of central blocks to which the vertex belongs, it indicates that structural aggregation for the vertex in the current meta-path has been completed; and
initiating semantic aggregation for the vertex once this condition is satisfied across all relevant meta-paths.

18. The method of claim 17, further comprising:
performing row-wise matrix multiplication and element-wise operations; and
storing weights and intermediate aggregation results for reuse during computation.

19. The method of claim 18, wherein, when computing degrees of overlap of the central blocks, the central blocks with higher degrees are prioritized for processing, wherein the block overlap graph is traversed in depth-first order, and the central blocks are sorted according to edge weights in the heterogeneous graph, such that the higher the edge weight, the higher the processing priority assigned to the corresponding central block.

20. A processor based on a heterogeneous graph neural network (HGNN), the processor being configured to execute the method of claim 11.
